(19) United States
(12) Patent Application Publication
(10) Pub. No.: US 2018/0218540 A1
(43) Pub. Date: Aug. 2, 2018

(54) SYSTEMS AND METHODS FOR INTERACTING WITH TARGETS IN A BUILDING

(71) Applicant: Johnson Controls Technology Company, Auburn Hills, MI (US)

(72) Inventors: Ashok Sridharan, Tiruchirappali (IN); Jeeva S, Salem District (IN); Jayesh Patil, Borivali West Mumbai (IN); Subrata Bhattacharya, Mumbai (IN); Shyam Sunder M, Pune (IN); Ankur Thareja, Alwar (IN)

(73) Assignee: Johnson Controls Technology Company, Auburn Hills, MI (US)

(21) Appl. No.: 15/872,653

(22) Filed: Jan. 16, 2018

Related U.S. Application Data
(60) Provisional application No. 62/452,316, filed on Jan. 30, 2017.

(51) Int. Cl. G06T 19/00; G06K 9/00; G06T 19/20; G06K 9/64; G06T 7/246

(52) U.S. Cl. CPC G06T 19/006; G06K 9/00671; H04W 88/02; G06K 9/64; G06T 7/251; G06T 19/20

(57) ABSTRACT

A system for locating a target in a building includes a mobile application and a remote system. The mobile application is for implementation on a mobile device including a camera configured to be utilized by the mobile application to selectively obtain a first image data of a first environment. The remote system is configured to selectively receive the first image data from the mobile application. The remote system is also configured to compare, in response to receiving the first image data from the mobile application, the first image data to a database of targets. The remote system is also configured to determine if a portion of the first image data is indicative of a target in the database of targets.

CROSS-REFERENCE TO RELATED PATENT APPLICATION

This Application claims priority to U.S. Provisional Patent Application No. 62/452,316 filed on Jan. 30, 2017, the entire disclosure of which is incorporated by reference herein.

### BACKGROUND

The present disclosure relates generally to a building management system (BMS) and more particularly to various systems and methods for recognizing, identifying, and tracking targets such as BMS components and other devices in a building. These systems and methods enhance interaction with, and visualization of, a BMS by a user such as an operator, a service engineer, a technician, an installation engineer, or, in some cases, a building user.

In general, a BMS is a system of devices configured to control, monitor, and/or manage equipment in or around a building or building area. A BMS can include, for example, an HVAC system, a security system, a lighting system, a fire alerting system, any other system that is capable of managing building functions or devices, or any combination thereof.

A BMS may include one or more computer systems (e.g., servers, BMS controllers, etc.) that serve as enterprise-level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human/machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

Interacting with various components of the BMS is often a cumbersome and expensive endeavor. Operators typically require special skills and training to operate components in the BMS. Issues that arise with components of the BMS may be difficult to understand and may take time to diagnose. Accordingly, information from the BMS is typically only available to a select number of individuals. Due to the large number of BMS components in typical buildings, interaction with many BMS components is impractical. As a result, operators are often unable to fully or efficiently interact with the components in a building.

Additionally, there is currently no simple way of comparing the performance of different products. For example, salesmen cannot demonstrate how one product would operate in a building by displaying a first set of live data and then demonstrate how another product would operate in the building by displaying a second set of live data. Currently, there is no mechanism by which remote technical assistance can be provided for a component by analyzing a photograph of that component.

### SUMMARY

One implementation of the present disclosure relates to a system for locating a target in a building. The system includes a mobile application and a remote system. The mobile application is for implementation on a mobile device including a camera configured to be utilized by the mobile application to selectively obtain a first image data of a first environment. The remote system is configured to selectively receive the first image data from the mobile application. The remote system is also configured to compare, in response to receiving the first image data from the mobile application, the first image data to a database of targets. The remote system is also configured to determine if a portion of the first image data is indicative of a target in the database of targets. The remote system is also configured to transmit, in response to determining that a portion of the first image data is indicative of a determined target, a target indication to the mobile application, the target indication comprising a 3D model associated with the determined target. The mobile application is further configured to selectively provide, in response to receiving the target indication from the remote system, the 3D model on a display of a mobile device.

Another implementation of the present disclosure relates to a system for locating a target in a building. The system includes a mobile application and a remote system. The mobile application is for implementation on a mobile device and configured to communicate via a network. The mobile device includes an imaging device, a display, and a communications device. The imaging device is configured to be utilized by the mobile application to selectively obtain image data of an environment. The display is configured to selectively provide the image data to a user. The display is also configured to receive a first command from the user. The communications device is configured to transmit, in response to receiving the first command from the user, the image data via the network. The remote system is configured to communicate via the network. The remote system is configured to selectively receive the image data from the mobile device via the network. The remote system is also configured to compare, in response to receiving the image data from the mobile device, the image data to a database of targets. The remote system is also configured to determine if a portion of the image data is indicative of a target in the database of targets. The remote system is also configured to transmit, in response to determining that a portion of the image data is indicative of a determined target in the database of targets, a target indication to at least one of the mobile device or a building management system (BMS) via the network. The target indication includes a 3D model associated with the target.

Yet another implementation of the present disclosure relates to a system for locating a target in a building. The system includes a mobile application and a remote system. The mobile application is for implementation on a mobile device. The mobile application is configured to obtain a first image data of a first environment. The mobile application is also configured to provide the first image data to a display of the mobile device. The mobile application is also configured to transmit the first image data. The remote system is communicable with the mobile application. The remote system is configured to receive the first image data from the mobile application. The remote system is also configured to compare the first image data to a database of targets. The remote system is also configured to determine if a portion of the first image data is indicative of a target in the database of targets. The remote system is also configured to transmit, in response to determining that a portion of the first image data is indicative of a determined target in the database of targets, a target indication to the mobile application. The mobile application is configured to provide the target indication on the display of the mobile device.

Yet another implementation of the present disclosure relates to a method for interacting with a target in a building. The method includes obtaining image data using a camera on a mobile device and displaying the image data on a display of the mobile device. The method also includes analyzing the image data to determine if a portion of the image data is indicative of a target. In some embodiments, the method includes retrieving a 3D model associated with the target in response to a determination that a portion of the image data is indicative of a target. The method may include displaying the 3D model on top of the image data on the display such that the location of the 3D model on the display substantially covers the portion of the image data that was indicative of the target.

Yet another implementation of the present disclosure relates to a system for interacting with a target in a building. The system includes a mobile application for implementation on a mobile device having a camera and a display, a network, and a remote system. The mobile application is configured to obtain image data of an environment using the camera. The mobile application is also configured to transmit the image data to the remote system. The remote system is configured to compare the image data to a database of targets to determine if a portion of the image data is indicative of a target. The remote system is also configured to transmit a target indication to the mobile device in response to determining that a portion of the image data is indicative of the target. The target indication includes a 3D model associated with the target. The mobile application is configured to display the 3D model on the display of the mobile device.

Yet another implementation of the present disclosure relates to a method for interacting with a target in a building. The method includes obtaining image data of an environment using a camera on a mobile device. The method may also include displaying the image data on a display of the mobile device. In some embodiments, the method also includes analyzing the image data to determine if a target is in the environment. The method also includes, in response to determining that a target is in the environment, retrieving a 3D model associated with the target. In some embodiments, the method also includes displaying the 3D model on top of the image data on the display. The method also includes maintaining a position of the 3D model on the display when the target is no longer in the environment.

Yet another implementation of the present disclosure relates to a system for interacting with a target in a building. The system includes a mobile application for implementation on a mobile device having a camera and a display, a network, a building management system, and a remote system. The mobile application may be configured to obtain image data of an environment using the camera. The mobile application is also configured to transmit the image data to the remote system. The remote system may be configured to compare the image data to a database of targets to determine if a portion of the image data is indicative of a target. The remote system may also be configured to transmit a target indication to the mobile device in response to determining that a portion of the image data is indicative of the target. The target indication may include a 3D model associated with the target. The mobile application may be configured to query the building management system for operating parameters associated with the target in response to receiving the target indication. The mobile application is also configured to provide the 3D model to an operator on the display of the mobile device. The mobile application is configured to selectively provide the operating parameters from the building management system on top of the 3D model.

Yet another implementation of the present disclosure relates to a method for interacting with a target in a building. The method includes obtaining image data of an environment using a camera on a mobile device. The method also includes displaying the image data on a display of the mobile device. The method also includes analyzing the image data to determine if a target is in the environment. The method may also include, in response to determining that a target is in the environment, retrieving a 3D model associated with the target. The method also includes displaying the 3D model on top of the image data on the display. The method also includes receiving a command from the operator on the mobile device. The method may also include, in response to the command, at least one of: partially exploding the 3D model and displaying documentation associated with the target to the user.

### BRIEF DESCRIPTION OF THE DRAWINGS

FIG. 1 is a drawing of a building equipped with a building management system (BMS), according to an exemplary embodiment.

FIG. 2 is a block diagram of a waterside system which may be used to provide heating and/or cooling to the building of FIG. 1, according to an exemplary embodiment.

FIG. 3 is a block diagram of an airside system which may be used to provide heating and/or cooling to the building of FIG. 1, according to an exemplary embodiment.

FIG. 4 is a block diagram of a BMS which may be used to monitor and control building equipment in the building of FIG. 1, according to an exemplary embodiment.

FIG. 5A is a flow diagram illustrating a system for interacting with a target of the building of FIG. 1 on a mobile device using an application running on the mobile device, according to an exemplary embodiment.

FIG. 5B is a flow diagram of the process described in FIG. 5A, according to an exemplary embodiment.

FIG. 6 is a block diagram of a mobile device for use in the process described in FIG. 5A, according to an exemplary embodiment.

FIG. 7 is an illustration of the mobile device shown in FIG. 6 including a mobile application used to implement the process described in FIG. 5B, according to an exemplary embodiment.

FIG. 8 is an image of a user interface for facilitating detection of a target which can be generated by the mobile application shown in FIG. 6, according to an exemplary embodiment.

FIG. 9 is an image of a user interface for rotating a 3D model of a target which can be generated by the mobile application shown in FIG. 6, according to an exemplary embodiment.

FIG. 10 is an image of a user interface for viewing an exploded view of a target which can be generated by the mobile application shown in FIG. 6, according to an exemplary embodiment.

FIG. 11A is an image of a user interface for viewing an online values pane for a target which can be generated by the mobile application shown in FIG. 6, according to an exemplary embodiment.

FIG. 11B is a block diagram of a system for updating a user interface, according to an exemplary embodiment.

FIG. 12 is an image of a user interface for viewing documentation associated with a target which can be generated by the mobile application shown in FIG. 6, according to an exemplary embodiment.

FIG. 13 is an image of a user interface for holding a position of a 3D model of a target on a display which can be generated by the mobile application shown in FIG. 6, according to an exemplary embodiment.

FIG. 14 is an image of another user interface for facilitating detection of a target which can be generated by the mobile application shown in FIG. 6, according to an exemplary embodiment.

FIG. 15 is an image of a user interface for viewing a 3D model of a target which can be generated by the mobile application shown in FIG. 6, according to an exemplary embodiment.

FIG. 16 is an image of another user interface for viewing a 3D model of a target which can be generated by the mobile application shown in FIG. 6, according to an exemplary embodiment.

FIG. 17 is an image of another user interface for holding a position of a 3D model of a target on a display which can be generated by the mobile application shown in FIG. 6, according to an exemplary embodiment.

FIG. 18 is an image of another user interface for viewing an online values pane for a target which can be generated by the mobile application shown in FIG. 6, according to an exemplary embodiment.

### DETAILED DESCRIPTION

### Overview

Referring generally to the FIGURES, systems and methods for interacting with targets (e.g., components, rooms, zones, floors, etc.) in a building having a building management system (BMS) are shown, according to an exemplary embodiment. A BMS is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof.

The systems and methods described herein may be used to generate 3D models of the targets in the building and to visualize and control content (e.g., operating parameters, etc.) associated with these targets. In some embodiments, the systems and methods described herein utilize a mobile device that analyzes image data obtained from a camera on a mobile device to determine if a portion of the image data is indicative of a target. The image data may be continuously provided to the operator regardless of whether or not a portion of the image data is indicative of a target.

If a target is detected, a 3D model is displayed on top of the target. The operator may interact with the 3D model to manipulate the target (e.g., rotate, zoom, pan, etc.), to visualize operating parameters of the target (e.g., to observe a temperature reading associated with the target, to observe energy consumption of the target, etc.), to cause changes in the operating parameters of target (e.g., to increase a temperature setpoint associated with the target, etc.), to view partially exploded views of the target (e.g., to view a failure within the target, etc.), and to easily view documentation associated with the target (e.g., to view a user manual for the target, etc.). The mobile device may also display a description (e.g., a common name, etc.) of the target to the user.

In some implementations, the mobile device cooperates with a remote system and/or a building management system to analyze the images and provide the user with the 3D model. The location that the 3D model is displayed on the mobile device may be related to the position of the mobile device relative to the target. In some applications, an operator may hold (e.g., maintain, etc.) the position of the 3D model while freely moving the mobile device. This may allow the operator to use the 3D model to simulate how the 3D model would look in other locations in the building.

The systems and methods described herein make interaction with the building more desirable. Rather than being required to use a computer that is fixed at a control center to interact with the targets, the processes described herein facilitate direct interaction and visualization of the targets and associated operating parameters by the operator while the operator is proximate to (e.g., within a line of sight of, next to, in front of, etc.) the targets. In this way, the operator is no longer tied to the control center and can instead walk through the building while selectively analyzing targets along the way.

The systems and methods described herein make interacting with the targets easier and more straightforward than is currently possible. Rather than relying on highly skilled technicians, the operators can independently adjust operating parameters of the targets simply through a few selections. As a result, the processes described herein facilitate significant cost reduction in costs associated with operating and maintaining a building. Additional features and advantages of the present invention are described in greater detail below.

### Building Management System and HVAC System

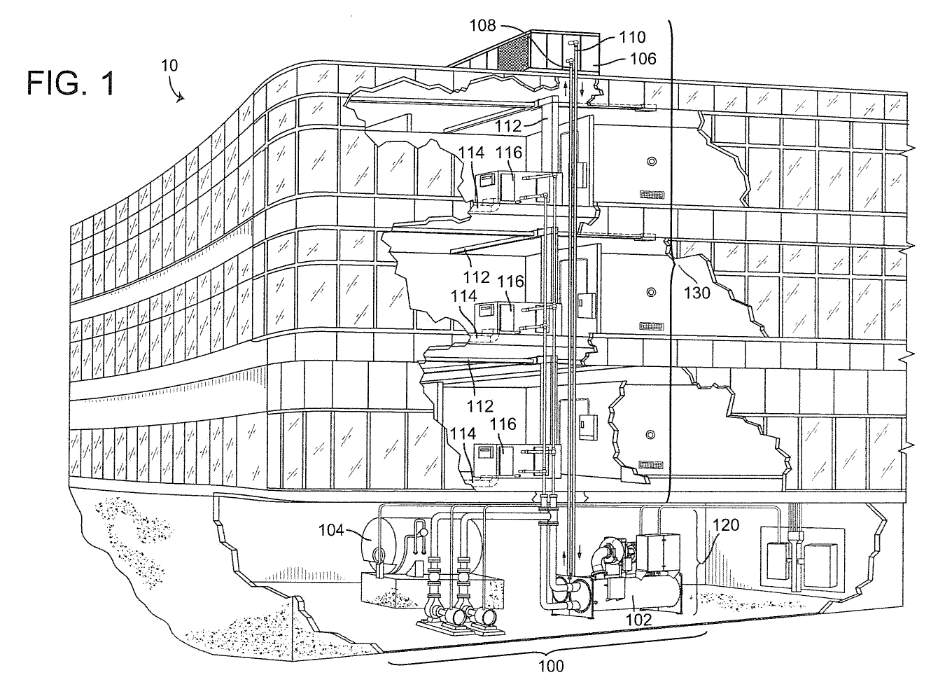

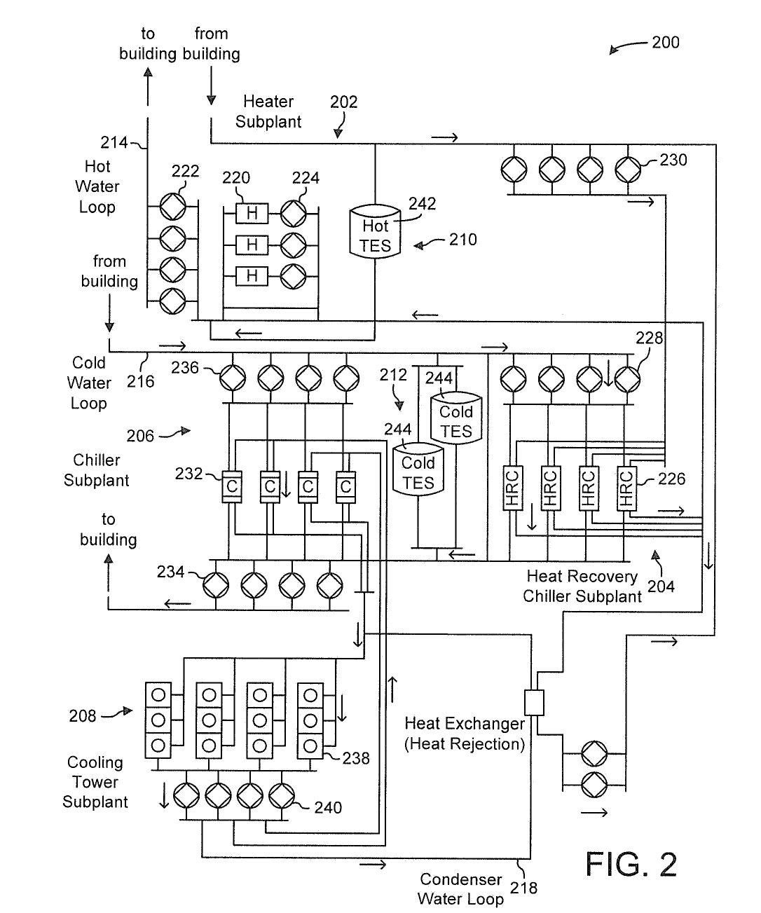

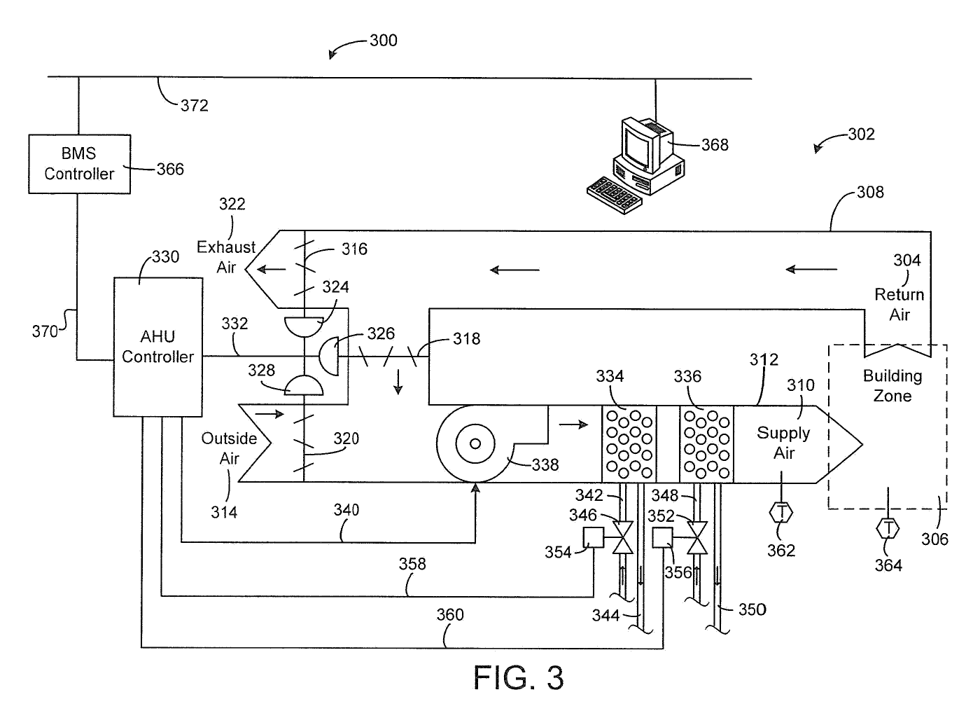

Referring now to FIGS. 1-4, an exemplary building management system (BMS) and HVAC system in which the systems and methods of the present invention may be implemented are shown, according to an exemplary embodiment. Referring particularly to FIG. 1, a perspective view of a building 10 is shown. Building 10 is served by a BMS which includes a HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

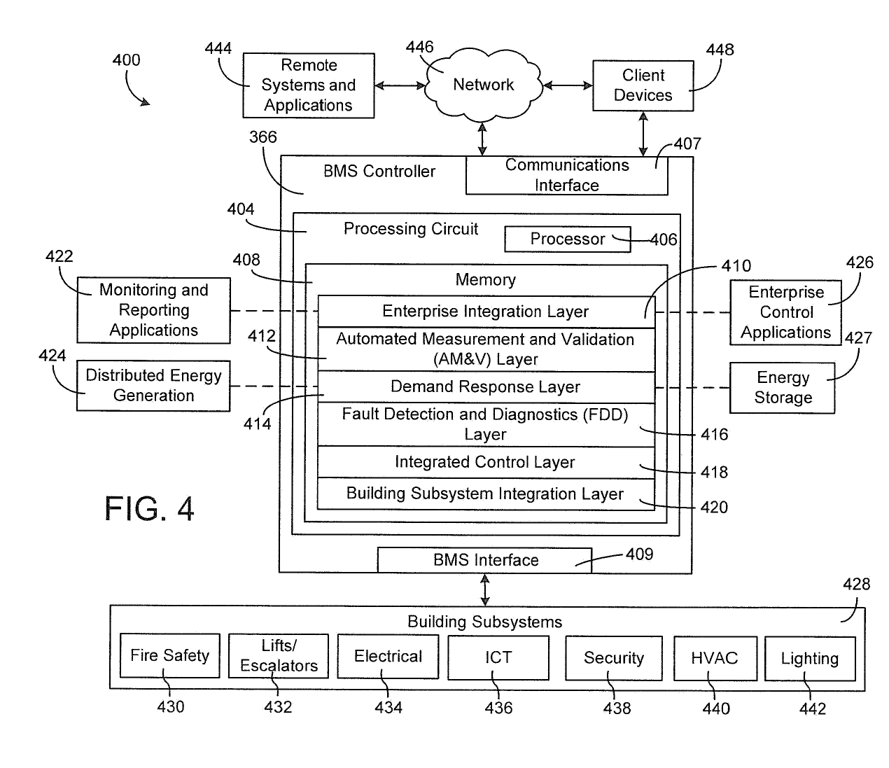

Referring now to FIG. 4, a block diagram of a building management system (BMS) 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### System For Target Interaction

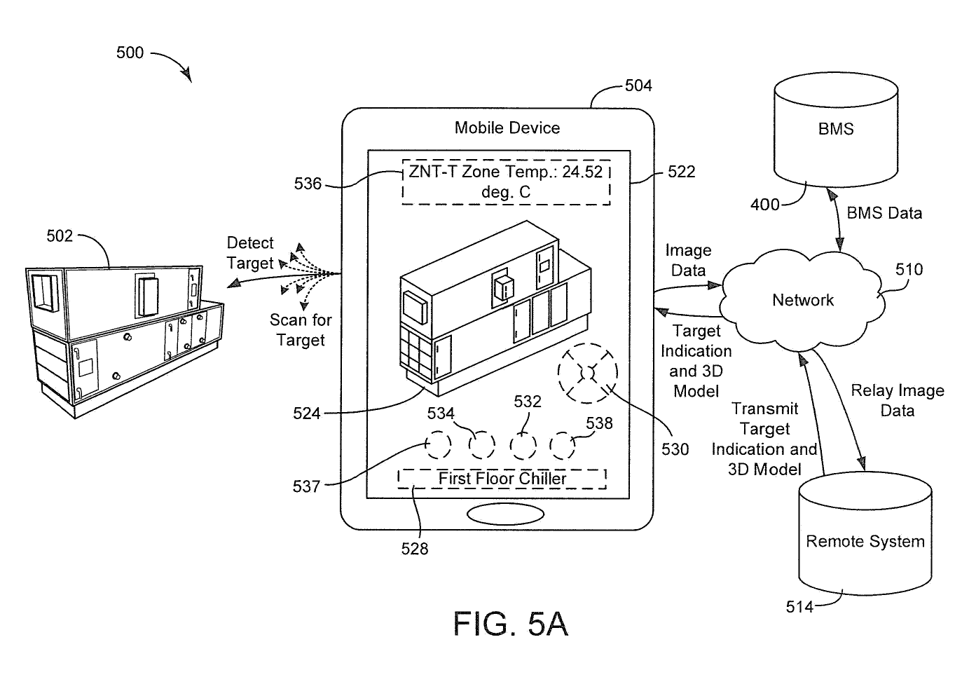

Referring now to FIG. 5A a system 500 for facilitating interaction with a target 502 is shown. System 500 may be utilized in various buildings such as, for example, hospitals, educational institutions (e.g., schools, libraries, universities, etc.), airports, cinema halls, museums, train stations, campuses, or other similar buildings. System 500 may be implemented in both new buildings and in retrofit applications (e.g., existing buildings, etc.). Target 502 may be a component, room, zone, space or other aspect of building 10. For example, target 502 may be a component of HVAC system 100 (e.g., chiller 102, boiler 104, AHU 106, control panel, valve, thermostat, light, etc.). In other examples, target 502 may be a wall mount sensor, a field controller (e.g., network automation engine (NAE) controller, forward error correction (FEC) controller, forward air control (FAC) controller, variable air volume modular assembly (VMA/VAV) controller, etc.), a field sensor, a pump, and other similar components of a building. In still other examples, target 502 may be a room (e.g., conference room, etc.). Through the use of system 500, operator interaction with a building is increased, maintenance and installation costs associated with the targets 502 may be decreased, energy savings may be increased, and the desirability of the building, including the BAS and/or BMS, may be increased.

As will be described further below, system 500 can be configured to provide a 3D model (e.g., augmented model, etc.) of target 502 to an operator. Currently, individuals can only interact with a component through physical interaction with the component. For example, individuals typically diagnose a failure within a component by taking the component apart to examine the failure. Often, physical interaction with the component, such as is required when performing repairs, requires user manuals and specialized training to complete. As a result, individuals are unable to easily interact with these components causing costs associated with the components to increase and desirability of the components and the building to decrease.

Currently, individuals who wish to interact with components are typically required to bring user manuals or computers (e.g., laptops, etc.) to the component for consultation during the interaction. In contrast, system 500 is implemented on a mobile device and does not require that an operator carry any manuals or laptops. As a result, system 500 is more desirable than conventional systems. In various embodiments, system 500 is implemented on a plurality of mobile devices (e.g., a first mobile device that obtains image data and a second mobile device that provides information related to the image data on a display, etc.).

Additionally, system 500 can be configured to easily change or monitor operating characteristics of target 502. Because system 500 can be utilized by an operator without specialized training or expertise, there is no need for a specially trained individual to perform these frequent tasks. Accordingly, system 500 facilitates increased efficiency in operating the building.

System 500 utilizes a mobile device 504 associated with an operator such as an engineer, a technician, an installation engineer, or, in some cases, a building user. In some applications, system 500 may be utilized by an operator with significantly less training and expertise than required for conventional component analysis and repairs. Mobile device 504 may be, for example, a smart phone, a personal electronic device, a tablet, a portable communications device, or any combination thereof.

System 500 is utilized on mobile device 504 through the use of a mobile application (e.g., app, program, module, etc.). The mobile application may be downloaded onto mobile device 504 through use of a network such as the internet. The mobile application may be configured to run in the background of mobile device 504 such that the operator can utilize other functionalize of mobile device 504 while implementing system 500. In some applications, the mobile application facilitates communication between multiple mobile devices 504 such that the system 500 is implemented across a plurality of mobile devices 504.

Mobile device 504 can be configured to scan for target 502. In one exemplary embodiment, mobile device 504 includes a camera. Following this embodiment, an operator may manipulate the camera (i.e., by moving mobile device 504, etc.) in order to change a field of view of the camera. While mobile device 504 is scanning for target 502, mobile device 504 is obtaining image data (e.g., from the camera, etc.). In various embodiments, system 500 does not utilize a marker (e.g., sticker, etc.) that conveys an identification of a component when the marker is scanned. However, in some alternative embodiments, system 500 utilizes a marker, such as a QR code, bar code, QR bar code, or Vuforia 3D marker. In some applications, system 500 does not require the use of headsets (e.g., virtual reality headsets, etc.). Accordingly, system 500 may be significantly less expensive, and therefore more desirable, than conventional systems.

System 500 is configured to compare the image data from mobile device 504 to a database to determine if the image data is indicative of target 502. The image data may be a derivative (e.g., a discrete derivative, a portion, a discrete portion, etc.) of image data collected by mobile device 504. This comparison may generate a target indication that signals that the image data is indicative of target 502. System 500 may implement various mechanisms for analyzing the image data and comparing it to the database. For example, system 500 may include components to perform edge detection, shape recognition, color detection, object recognition, and other similar image analyses.

In some embodiments, system 500 includes a network 510 and a remote system 514. In Mobile device 504 may communicate (e.g., transmits, etc.) the image data to network 510 which relays the image data to remote system 514. In these embodiments, remote system 514 contains the database (e.g., in a memory, etc.), in addition to, or in place of, the database in mobile device 504. In these embodiments, system 500 utilizes remote system 514 to compare the image data to the database to determine if the image data is indicative of target 502. If the image data is indicative of target 502, remote system 514 generates a target indication. Remote system 514 then transmits the target indication to network 510 that relays the indication to mobile device 504. According to various embodiments, remote system 514 is a cloud server. Remote system 514 may also be an enterprise server, server farm, or other similar server configuration.

In other embodiments, system 500 utilizes mobile device 504 to determine if the image data is indicative of target 502. For example, mobile device 504 may contain the database (e.g., in a memory, etc.). System 500 may also utilize mobile device 504 to communicate (e.g., transmits, etc.) the image data to a network 510 that relays the image data to a remote system 514. In these embodiments, remote system 514 contains the database (e.g., in a memory, etc.), in addition to, or in place of, the database in mobile device 504. Remote system 514 then compares the image data received from network 510 to the database to determine if the image data is indicative of target 502. If the image data is indicative of target 502, system 500 utilizes remote system 514 to generate a target indication. Remote system 514 then transmits the target indication to network 510 that relays the indication to mobile device 504. According to various embodiments, remote system 514 is a cloud server. Remote system 514 may also be an enterprise server, server farm, or other similar server configuration.

While system 500 is utilizing mobile device 504 to scan, the image data may be displayed to the operator on a display 522 of mobile device 504. Display 522 is configured to display a real-time image within a line of sight of mobile device 504. System 500 may be configured to utilize display 522 to display a substantially (e.g., approximately, etc.) real-time image of a location proximate to mobile device 504 (i.e., through the camera, etc.). For example, display 522 may display an image of an environment including target 502 such as a control room, a boiler room, or other similar environments.

Once target 502 is detected, system 500 generates a 3D model 524 of target 502. In various embodiments, 3D model 524 is included in the target indication. 3D model 524 may be, for example, a computer-aided design model. Similar to the database for image data, at least one of mobile device 504 and remote system 514 includes a database of 3D models. For example, system 500 may utilize remote system 514 to locate 3D model 524 in a database of 3D models based on its association with target 502 and then transmit 3D model 524 along with the target indication to network 510.

System 500 displays 3D model 524 on display 522. According to various embodiments, 3D model 524 for target 502 is overlaid on the image of the environment displayed on display 522. For example, 3D model 524 may be shown on display 522 in the location of target 502 such that the operator sees 3D model 524 instead of, or on top of, target 502. In this way, system 500 may augment an image of target 502 with 3D model 524 as seen by the operator through display 522 and, thus, change a state of display 522. After 3D model 524 is displayed, system 500 is configured such that display 522 is continuously updated while the mobile application is running. For example, if the camera on mobile device 504 is no longer pointed at target 502, then system 500 will cease to display 3D model 524. In various embodiments, system 500 displays a description 528 (e.g., common name, serial number, identification number, location, etc.) of target 502 along with 3D model 524. Description 528 may assist the operator in identifying target 502. For example, when target 502 is a chiller, description 528 may be “second floor chiller.” In various embodiments, system 500 is configured such that a first mobile device 504 obtains image data for target 502 and a second mobile device 504 provides the image data on a display of the second mobile device 504 (e.g., similar to display 522, etc.). In this embodiment, the first mobile device 504 may communicate directly with the second mobile device 504, or the first mobile device 504 may communication with the second mobile device 504 through network 510 and/or remote system 514. Where two mobile devices 504 are utilized, each mobile device 504 may utilize the mobile application to facilitate such communication.

System 500 may be utilized as the operator is walking through a building (e.g., building 10, etc.). As the operator walks through the building, the operator may selectively utilize system 500 for various targets 502. For example, when walking by a chiller, the operator may be provided with 3D model 524 for the chiller. The operator may ensure that the chiller is operating properly and then utilize system 500 to examine a heat exchanger. In some cases, the operator may prevent 3D models 524 from being shown on display 522, such as through the use of a hide or sleep setting, as the operator walks through the building.

In some applications, system 500 may be implemented in a repair mode. While in the repair mode, only targets 502 that are in need of repair may be detected by mobile device 504. For example, in a room with a chiller that has a leak and an AHU, system 500 may only provide 3D model 524 for the chiller. In other implementations, for a target 502 in need of repair, 3D model 524 associated with target 502 may be configured to highlight the area of target 502 that is in need of repair. For example, if a generator needs an oil filter replacement, system 500 may be implemented such that 3D model 524 for the generator highlights the oil filter and illustrates a sequence for removing the oil filter from the generator.

Using system 500, the operator may perform various interactions with 3D model 524 through mobile device 504. For example, when 3D model 524 is displayed, an input button 530 may be shown on display 522. Input button 530 facilitates operator manipulation of 3D model 524 using system 500. For example, input button 530 may facilitate rotation of 3D model 524 about an axis. In one example, input button 530 may be utilized by an operator to rotate 3D model 524 three-hundred and sixty degrees about a central axis. In some applications, rotation of 3D model 524, such as through the use of input button 530, may reveal an image of target 502 beneath 3D model 524. In other examples, input button 530 facilitates panning, alone or in combination with rotation, of 3D model 524.

In addition to, or instead of, input button 530, system 500 may utilize display 522 to facilitate operator interaction with 3D model 524. For example, an operator may bring two fingers that are touching display 522 together (i.e., in a pinching motion, etc.) to cause zooming in and/or out of 3D model 524. Similarly, display 522 could be configured to translate swiping motions on display 522 into rotations and/or translations of 3D model 524.

In addition to input button 530, system 500 may show an animation button 532 on display 522. According to various embodiments, when the operator selects animation button 532, such as through tapping animation button 532 with a finger, 3D model 524 transitions to an at least partially exploded view. This partially exploded view facilitates installation, uninstallation, mounting, and maintenance of target 502. For example, system 500 may utilize animation button 532 to allow the operator to understand wiring deep inside of target 502 without requiring the operator to physically disassemble target 502 to examine the wiring. In this way, interaction with target 502 is more desirable. In some applications, the length of time during which the operator has pressed animation button 532 may control the degree to which 3D model 524 is exploded. For example, a longer depression of animation button 532 may result in 3D model 524 being more exploded than for a shorter depression.

According to various embodiments, system 500 is configured such that mobile device 504 is communicable with BMS 400 via network 510. In this way, mobile device 504 can be provided substantially real-time information relating to target 502 from BMS 400. For example, BMS 400 may provide mobile device 504 with operating parameters (e.g., operating temperature, power consumption, etc.) related to target 502. Similarly, BMS 400 may provide mobile device 504 with information from other targets 502 (e.g., temperature in a room, etc.) that are impacted by target 502 (e.g., a chiller that provides cooling to the room, etc.). For example, if target 502 is a chiller that is operable to control temperature in a room, BMS 400 may provide mobile device 504 the temperature of the room.

According to an alternative embodiment, system 500 receives location information for target 502 from BMS 400 and/or remote system 514. For example, when the target indication is received, system 500 may transmit the target indication to BMS 400 along with a location (e.g., the location of mobile device 504), to receive a refined target indication. In one example, target 502 is a chiller, and system 500 transmits the target identification to BMS 400 which identifies a particular model and manufacturer for the chiller based on the location of mobile device 504.

In some embodiments, BMS 400 may contain a database of all targets 502 and associated 3D models 524 that system 500 may utilize, rather than or in addition to databases in remote system 514 and/or mobile device 504. Similarly, system 500 may be implemented such that the database for targets 502 is contained in one of remote system 514 and BMS 400 and the database for 3D models 524 is contained in the other of remote system 514 and BMS 400.

System 500 may also be configured to show an online values button 534 on display 522. When the operator selects online values button 534, system 500 may cause an online values pane 536 to be displayed. Online values pane 536 may include information obtained from, for example, BMS 400. This information is associated with the operation of target 502 and may be updated in substantially real-time. For example, online values pane 536 may include a current temperature associated with target 502 and a setpoint temperature associated with target 502. In other applications, online values pane 536 may display other information, such as operating temperature, alarms, air flow speeds, power consumption, occupancy, illumination levels, oil life, fuel consumption, energy consumption, maintenance history, filter life, location information, proximity information, service information, usage information, installation information, upgrade information, or other similar measurements and information.

According to various embodiments, system 500 is configured such that online values pane 536 is configured to selectively receive inputs from the operator to change operating characteristics of target 502. In some applications, online values pane 536 facilitates changing of a temperature output of target 502. For example, if target 502 is a chiller, online values pane 536 may facilitate changing of a temperature of the room to which target 502 is configured to control.

System 500 may also show a documentation button 537 on display 522. When the operator selects documentation button 537, system 500 may cause a document viewer to be shown on at least part of display 522. The document viewer may display pertinent documentation to the operator. For example, the document viewer may display product manuals, catalogues, tutorials (e.g., installation tutorials, service and maintenance tutorials, removal tutorials, etc.), installation manuals, service history, wiring diagrams, and other documentation to the operator. In some applications, the document viewer is shown full-screen on display 522. While in the document viewer, the operator may be able to scroll through the documentation through interaction with display 522 (e.g., through upward and downward finger strokes, etc.). Documentation provided in the document viewer may either be stored locally, in mobile device 504, or may be downloaded from remote system 514 through network 510. Similar to 3D model 524, the documentation may be provided to mobile device 504 along with the target indication.

Documentation button 537 may be particularly desirable because it eliminates the need for operators to carry physical copies of the documentation. In many applications, documentation is quite lengthy and cumbersome to use. Through the use of system 500, the operator may easily view and search within electronic documents provided in the document viewer accessed through use of documentation button 537. In various implementations, system 500 only provides the operator with documentation relevant to target 502 when documentation button 537 is selected. In this way, system 500 is advantageous compared to other electronic storage mechanisms which do not filter available documentation based on target 502.

System 500 may also show a hold button 538 on display 522. When the operator selects hold button 538, display 522 ceases to update with new image data and the environment surrounding 3D model 524 is held in place. Hold button 538 allows the operator to move mobile device 504 relative to target 502. In this way the operator is not required to maintain a position while interacting with 3D model 524 through system 500.

According to various embodiments, the mobile application used by system 500 is implemented using Unity 3D software and C# programming language. In some embodiments, mobile device 504 is an Android® smartphone. In other embodiments, mobile device 504 is an iOS® or Windows® smartphone.

In some alternative embodiments, display 522 is supplemented by another display device such as a tablet, computer (e.g., laptop, etc.), or headset (e.g., augmented reality glasses, etc.). In these embodiments, information shown on display 522, as previously described in system 500, may be instead electively displayed on the additional display device. In some applications, certain information may be provided to the additional display device while other information is provided to display 522. For example, 3D model 524 may be displayed on the additional display device while input button 530 and online values pane 536 remain shown on display 522.

Referring now to FIG. 5B, a process 550 for interacting with target 502 is shown according to an exemplary embodiment. Process 550 includes first scanning for targets 502 in the environment using mobile device 504 (step 552). In some applications, the operator may move mobile device 504 thereby changing a field of view of the camera. In these embodiments, process 550 includes changing a field of view of the camera associated with mobile device 504 (step 554). In other applications, process 550 is implemented such that the field of view of the camera is not changed. In these applications, process 550 does not include step 554. Process 550 includes obtaining image data from the camera (step 556). For example, the camera may transmit image data to mobile device 504. According to various embodiments, process 550 includes displaying the image data to the operator on display 522 of mobile device 504 (step 558). For example, while the mobile application is running, image data from the camera may be displayed in substantially real time on display 522. In this way, the operator may orient the camera towards target 502. In other embodiments, the image data is not displayed to the operator on display 522. In these embodiments, process 550 does not include step 558.

In some embodiments, process 550 includes comparing the image data to a database on mobile device 504 to determine if the image data is indicative of target 502 (step 560). During process 550, this comparison may generate a target indication (step 562) signaling that the image data is indicative of target 502. However, in embodiments where the database is not stored on mobile device 504, process 550 may not perform step 560 or step 562.

In other embodiments, process 550 includes communicating the image data to network 510 (step 564) when the database is not stored on mobile device 504. Process 550 then relays the image data to remote system 514 or BMS 400 (step 566). Process 550 then compares the image data received from network 510 in step 566 to the database to determine if the image data is indicative of target 502 (step 568). If the image data is indicative of target 502, remote system 514 or BMS 400 generates a target indication (step 570). Remote system 514 or BMS 400 then transmits the target indication to network 510 (step 572) that relays the indication to mobile device 504 (step 574).

Once target 502 is detected, process 550 causes a 3D model 524 of target 502 to be generated that is included in the target indication. In this way, both the target indication and the 3D model 524 of target 502 are generated in step 562 and step 570. Process 550 may include locating 3D model 524 in a database in at least one of mobile device 504, BMS 400, and remote system 514. Process 550 also includes displaying 3D model 524 for target 502 to the operator on display 522 (step 576).

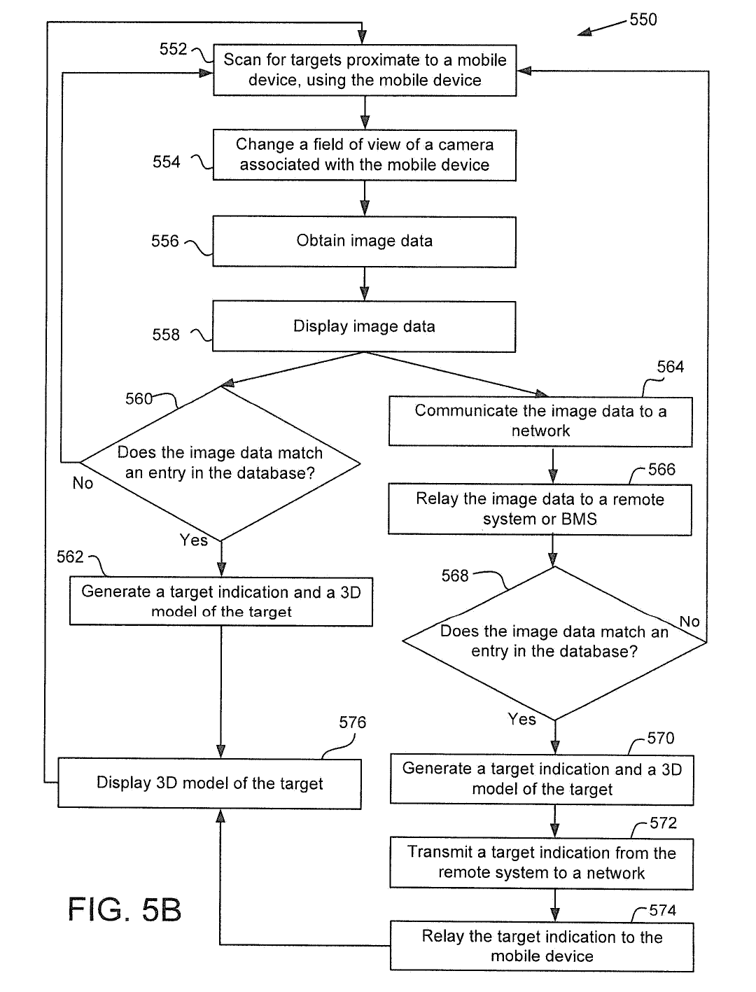

Referring now to FIG. 6, a block diagram illustrating mobile device 504 in greater detail is shown, according to an exemplary embodiment. As previously described, mobile device 504 includes display 522. Mobile device 504 may include an imaging device 600 and a communications device 602. Imaging device 600 may perform as the camera described above with respect to system 500 and process 550. Imaging device 600 may be a camera, a photosensor, a video camera, or other similar imaging devices. Communications device 602 may facilitate communication between mobile device 504 and network 510 and BMS 400. For example, communications device 602 may be any device capable of facilitating communication via wireless communication technologies (e.g., 5G, 4G, 4G LTE, 3G, etc.), Bluetooth (e.g., Bluetooth low energy, Bluetooth 4.0, etc.), Wi-Fi, NFC, ZigBee, near field communication (NFC), other similar communications, or any combination thereof.

Mobile device 504 also includes a processing circuit 604. Processing circuit 604 is configured to control mobile device 504 to implement, among other processes, process 550. Processing circuit 604 may be communicable connected to display 522, imaging device 600, and communications device 602. Processing circuit 604 includes a processor 606 and a memory 608. Processing circuit 604 may be communicable coupled to processor 606 and memory 608 such that processing circuit 604 can send and receive data via communications device 602. Processor 606 can be implemented as a general purpose processor, an application specific integrated circuit (ASIC), one or more field programmable gate arrays (FPGAs), a group of processing components, or other suitable electronic processing components.

Memory 608 (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present application. Memory 608 may be or include volatile memory or non-volatile memory. Memory 608 may include database components, object code components, script components, or any other type of information structure for supporting the various activities and information structures described in the present application. According to an exemplary embodiment, memory 608 is communicably connected to processor 606 via processing circuit 604 and includes computer code for executing (e.g., by processing circuit 604 and/or processor 606) one or more of the processes described herein.

According to various embodiments, memory 608 includes various modules for controlling operation of mobile device 504. In an exemplary embodiment, memory 608 includes a mobile application module 610. Mobile application module 610 is configured to facilitate operation of a mobile application 611 used by mobile device 504 to implement system 500 and process 550. For example, mobile application module 610 may store, update, and run mobile application 611. Mobile application module 610 may facilitate the display of 3D model 524, description 528, input button 530, animation button 532, online values button 534, online values pane 536, documentation button 537, and hold button 538 on display 522. Mobile application module 610 may also facilitate the translation of inputs received from the operator via display 522 into commands executed within the mobile application. While not shown, mobile application module 610 may also facilitate the translation of inputs received from the operator via auxiliary devices (e.g., physical buttons, voice commands, gaze commands, etc.).

Memory 608 may also include a target detection module 612. In some embodiments, target detection module 612 is configured to facilitate analysis of image data from imaging device 600 to determine if the image data is indicative of target 502. Target detection module 612 may implement, for example, edge detection, shape detection, objection recognition, and other similar image analyses on the image data. Target detection module 612 receives image data from imaging device 600.

Memory 608 may also include a target tracking module 614. In some embodiments, target tracking module 614 is configured to substantially track the location of target 502. For example, as mobile device 504, and therefore imagine device 600, is moved relative to target 502 (e.g., as the operator is walking, etc.), target tracking module 614 may track target 502 through a field of view of imagine device 600. In one example, as the operator walks from a first position to a second position, the relative location of target 502 may also transition from a first position to a second position. By tracking the location of target 502 using target tracking module 614, the position of 3D model 524 on display 522 can be correspondingly updated so that 3D model 524 remains substantially on top of target 502 on display 522. In various embodiments, target tracking module 614 provides data to target detection module 612 that expedites the process of determining if the image data is indicative of target 502. For example, target tracking module 614 may indicate a portion of the image data that should be analyzed first (e.g., be prioritized, etc.). Alternatively, target tracking module 614 may indicate to target detection module 612 that a threshold for determining if the image data is indicative of target 502 should be lower.

Memory 608 may also include a target information retrieval module 616. In some embodiments, target information retrieval module stores the database of targets 502 and 3D models 524. In other embodiments, target information retrieval module 616 receives a target indication and 3D model 524 from at least one of BMS 400 and remote system 514 over network 510. Target information retrieval module 616 may also receive information from BMS 400 relating to target 502. For example, target information retrieval module 616 may receive operating conditions of target 502 from BMS 400 and provide the operating conditions to the operator when online values pane 536 is displayed. Similarly, target information retrieval module 616 may determine, or receive, description 528 for target 502 and display description 528 to the operator.

### User Interfaces

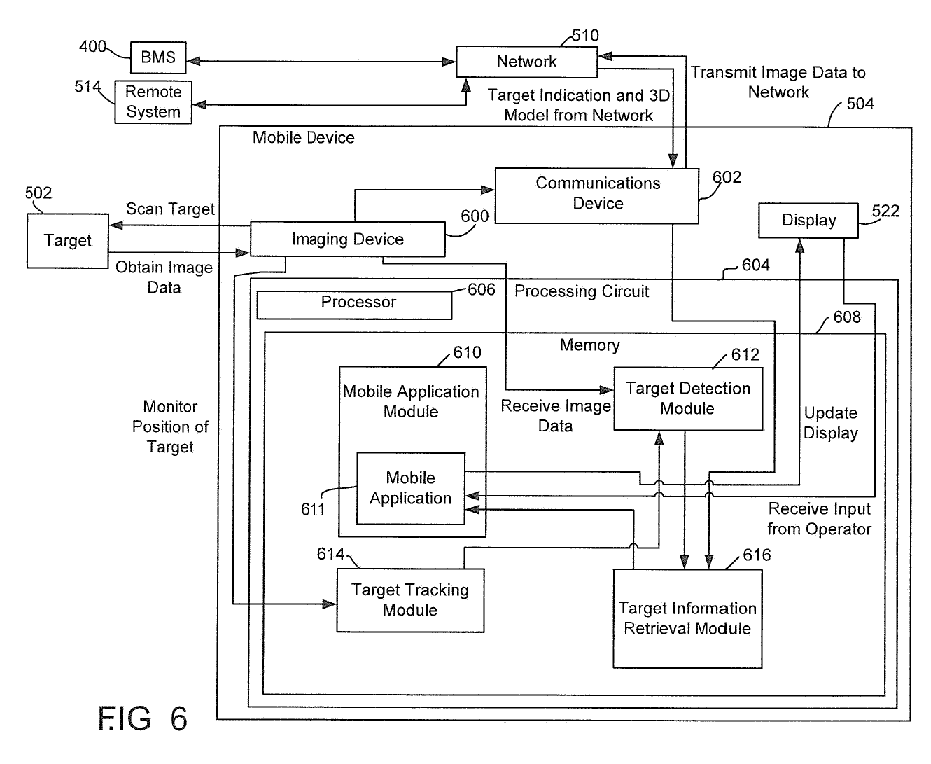

FIGS. 7-18 illustrate various user interfaces which can be generated by a mobile application 611 for implementing system 500 and/or process 550 and running on mobile device 504. Mobile application 611 may perform as the mobile application described above with respect to system 500 and process 550. In one example, mobile device 504 is only capable of detecting target 502 when mobile application 611 is running. However, it is contemplated that mobile device 504 may be capable of detecting target 502 when mobile application 611 is not running in other embodiments. Mobile application 611 may transmit push notifications to mobile device 504. For example, when mobile device 504 detects target 502, mobile application 611 may cause a notification to be pushed to a display on mobile device 504. In this way, mobile application 611 may effectively change a state of mobile device 504 when target 502 is detected.

As shown in FIG. 7, mobile application 611 includes an icon 702. In order to run mobile application 611, the operator may first select icon 702. After selecting icon 702, mobile application 611 is shown on display 522. In many applications, mobile application 611 is shown on display 522 in full-screen. However, in other applications, mobile application 611 may be selectively shown on display 522 in less than full-screen.

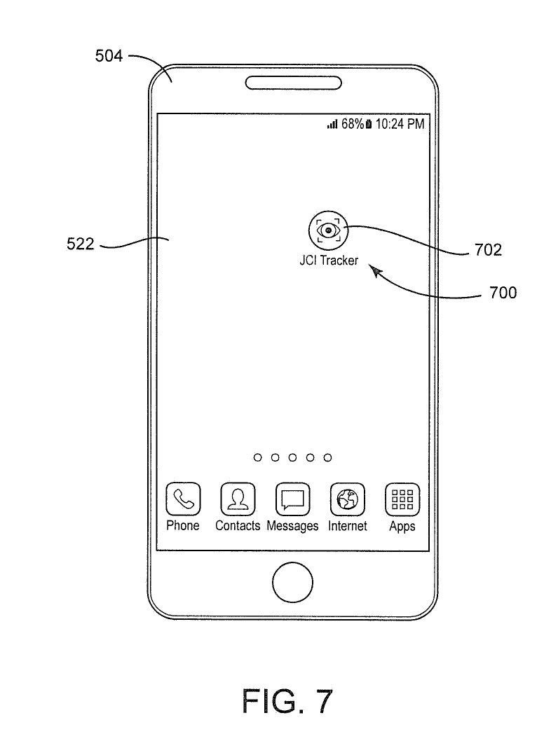

Referring now to FIG. 8, a device tracking interface 800 which can be generated by mobile application 611 is shown, according to an exemplary embodiment. Device tracking interface 800 is shown to include a centering icon 802 and hold button 538. In some embodiments, centering icon 802 is fixed at a center point of display 522 when device tracking interface 800 is shown on display 522 in full-screen. Similarly to hold button 538, centering icon 802 is superimposed on display 522 such that images shown on display 522 may be moved relative to centering icon 802. Centering icon 802 is configured to assist the operator in centering a field of view of imagine device 600 on target 502 and thereby facilitate detection of target 502. In many applications, moving mobile device 504, and therefore imaging device 600, such that target 502 is at least partially contained within centering icon 802 facilitates more rapid detection of target 502. As shown in FIG. 8, target 502 is partially contained within centering icon 802. Once target 502 is detected and 3D model 524 is displayed, centering icon 802 may be hidden and not shown on display 522. In other applications, mobile application 611 does not utilize centering icon 802. Depending on the application, the shape, size, and configuration of centering icon 802 may be varied such that mobile application 611, and therefore system 500 and/or process 550, is tailored for a target application.

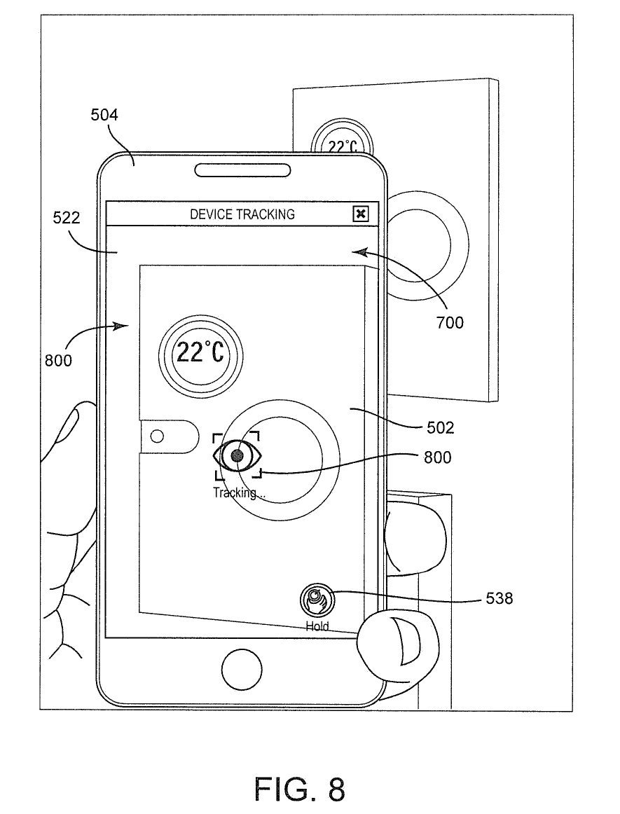

As shown in FIG. 9, device rotating interface 900 may include a 3D model 524. 3D model 524 can be displayed on top of (e.g., superimposed on, etc.) target 502 in device rotation interface 900. Also shown in FIG. 9, 3D model 524 has been rotated by the operator via device rotation interface 900 using input button 530. In some embodiments, device rotation interface 900 includes description 528, animation button 532, online values button 534, documentation button 537, and hold button 538, which may be the same as described with reference to FIG. 5A. Alternatively, 3D model 524 may be rotated on device rotating interface 900 by a sensed rotation of mobile device 504 (e.g., from sensors in mobile device 504, etc.).

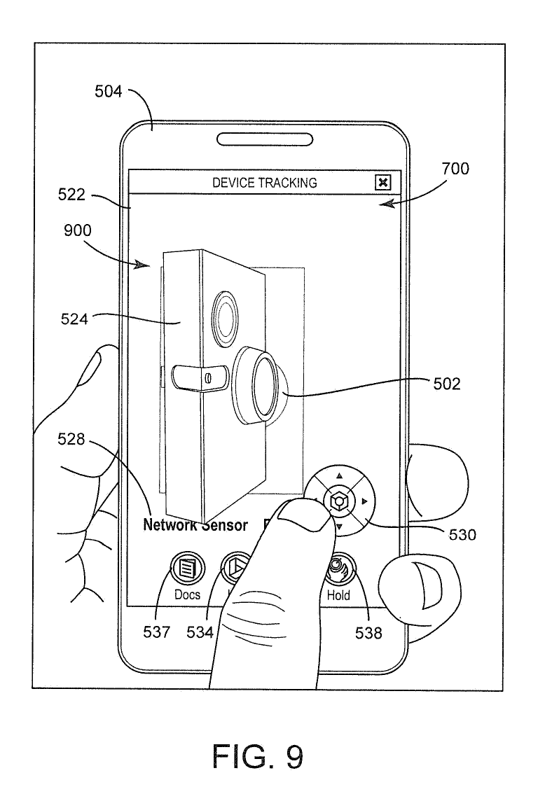

Referring now to FIG. 10, an animation interface 1000 which can be generated by mobile application 611 is shown, according to an exemplary embodiment. Animation interface 1000 may be displayed after the operator has selected animation button 532 in animation interface 1000. As shown, 3D model 524 has been partially exploded. In this way, animation interface 1000, as implemented through system 500 and/or process 550, facilitate increased understanding of how target 502 is constructed and assembled. In some embodiments, animation interface 1000 displays 3D model 524 operating in substantially real-time. For example, animation interface 1000 may be configured such that when target 502 is a pump, 3D model 524 displays a pump shaft and fan rotating continuously. 3D model 524 may be updated continuously such that as speed levels of components in target 502 change, the corresponding speed of components within 3D model 524 change accordingly. In this way, animation interface 1000 may allow the operator to visualize an operational status (e.g., state, phase, etc.) of target 502.

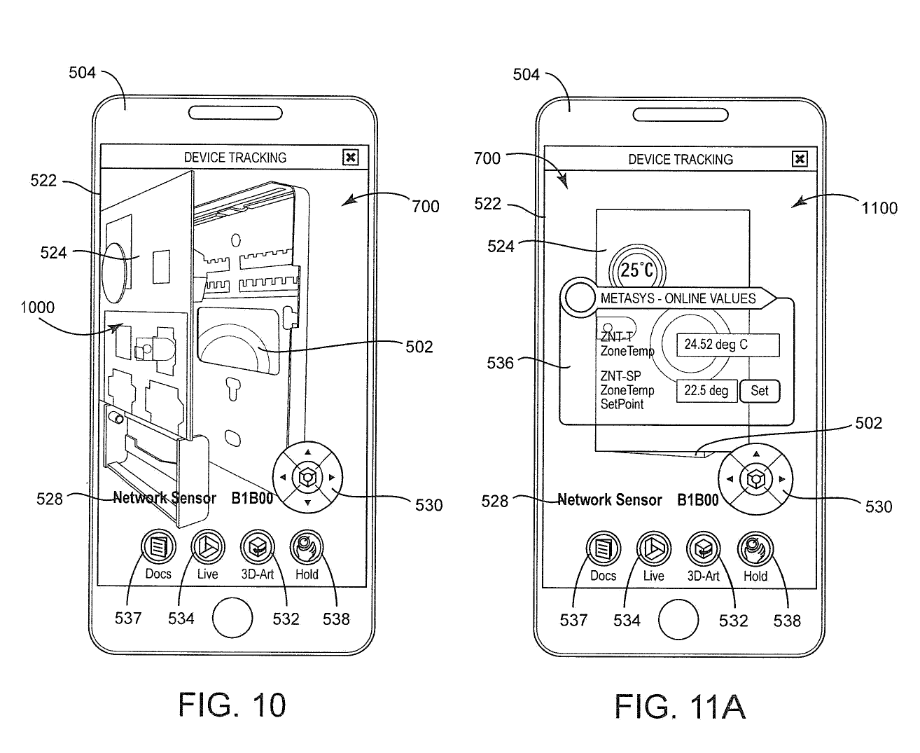

As shown in FIG. 11A, an online values interface 1100 which can be generated by mobile application 611 is shown. Online values interface 1100 may be generated after the operator has selected online values button 534. As shown, online values interface 1100 displays online values pane 536 on top of (e.g., superimposed on, etc.) 3D model 524. Online values interface 1100 may update online values pane 536 in substantially real-time with information obtained from, for example, BMS 400.

Referring now to FIG. 11B, a system 1102 for integrating BMS data with a building information model is shown, according to an exemplary embodiment. A building information model (BIM) is a representation of the physical and/or functional characteristics of a building. A BIM may represent structural characteristics of the building (e.g., walls, floors, ceilings, doors, windows, etc.) as well as the systems or components (e.g., targets 502, etc.) contained within the building (e.g., lighting components, electrical systems, mechanical systems, HVAC components, furniture, plumbing systems or fixtures, etc.).

In some embodiments, a BIM is a 3D graphical model of the building. A BIM may be created using computer modeling software or other computer-aided design (CAD) tools and may be used by any of a plurality of entities that provide building-related services. For example, a BIM may be used by architects, contractors, landscape architects, surveyors, civil engineers, structural engineers, building services engineers, building owners/operators, or any other entity to obtain information about the building and/or the components contained therein. A BIM may replace 2D technical drawings (e.g., plans, elevations, sections, etc.) and may provide significantly more information than traditional 2D drawings. For example, a BIM may include spatial relationships, light analyses, geographic information, and/or qualities or properties of building components (e.g., manufacturer details).

In some embodiments, a BIM represents building components as objects (e.g., software objects). For example, a BIM may include a plurality of objects that represent physical components (e.g., targets 502, etc.) within the building as well as building spaces. Each object may include a collection of attributes that define the physical geometry of the object, the type of object, and/or other properties of the object. For example, objects representing building spaces (e.g., targets 502, etc.) may define the size and location of the building space. Objects representing physical components (e.g., targets 502, etc.) may define the geometry of the physical component, the type of component (e.g., lighting fixture, air handling unit, wall, etc.), the location of the physical component, a material from which the physical component is constructed, and/or other attributes of the physical component.

In some embodiments, a BIM includes an industry foundation class (IFC) data model that describes building and construction industry data. An IFC data model is an object-based file format that facilitates interoperability in the architecture, engineering, and construction industry. An IFC model may store and represent building components in terms of a data schema. An IFC model may include multiple layers and may include object definitions (e.g., IfcObjectDefinition), relationships (e.g., IfcRelationship), and property definitions (e.g., IfcPropertyDefinition). Object definitions may identify various objects in the IFC model and may include information such as physical placement, controls, and groupings. Relationships may capture relationships between objects such as composition, assignment, connectivity, association, and definition. Property definitions may capture dynamically extensible properties about objects. Any type of property may be defined as an enumeration, a list of values, a table of values, or a data structure.

A BIM can be viewed and manipulated using a 3D modeling program (e.g., CAD software), a model viewer, a web browser, and/or any other software capable of interpreting and rendering the information contained within the BIM. Appropriate viewing software may allow a user to view the representation of the building from any of a variety of perspectives and/or locations. For example, a user can view the BIM from a perspective within the building to see how the building would look from that location. In other words, a user can simulate the perspective of a person within the building.

Advantageously, the integration provided by system 1102 allows dynamic BMS data (e.g., data points and their associated values) to be combined with the BIM. The integrated BIM with data from target 502 can be viewed using an integrated BMS-BIM viewer (e.g., running on mobile application 611, etc.). The BMS-BIM viewer uses the geometric and location information from the BIM to generate 3D representations of physical components and building spaces. In some embodiments, the BMS-BIM viewer functions as a user interface for monitoring and controlling the various systems and devices represented in the integrated BIM. For example, a user can view real-time data from target 502 and/or trend data for objects represented in the BIM simply by viewing the BIM with integrated data from target 502. The user can view BMS points, change the values of BMS points (e.g., setpoints), configure target 502, and interact with target 502 via the BMS-BIM viewer. These features allow the BIM with integrated data from target 502 to be used as a building control interface which provides a graphical 3D representation of the building and the equipment contained therein without requiring a user to manually create or define graphics for various building components.

Still referring to FIG. 11B, system 1102 is shown to include a BMS-BIM integrator 1104, an integrated BMS-BIM viewer 1106, a BIM database 1108, online values interface 1100, network 510, and BMS 400. In some embodiments, some or all of the components of system 500 are part of mobile application 611. For example, network 510 may be a building automation and control network (e.g., a BACnet network, a LonWorks network, etc.) used by mobile application 611 to communicate with BMS 400. BMS 400 may include various targets 502 such as HVAC equipment (e.g., chillers, boilers, air handling units pumps, fans, valves, dampers, etc.), fire safety equipment, lifts/escalators, electrical equipment, communications equipment, security equipment, lighting equipment, or any other type of equipment which may be contained within a building.

In some embodiments, BMS-BIM integrator 1104, integrated BMS-BIM viewer 1106, and BIM database 1108 are components of mobile application 611. In other embodiments, one or more of components 1104-1108 may be components of mobile device 504. For example, integrated BMS-BIM viewer 1106 may be an application running on mobile device 504 and may be configured to present a BIM with integrated BMS points via a user interface (e.g., online values interface 1100) of mobile device 504 (e.g., presented through mobile application 611, etc.). BMS-BIM integrator 1104 may be part of the same application and may be configured to integrate BMS points with a BIM model based on user input provided via online values interface 1100. In further embodiments, integrated BMS-BIM viewer 1106 is part of mobile device 504 which receives a BIM with integrated BMS points from a remote BMS-BIM integrator 1104. It is contemplated that components 1104-1108 may be part of the same system/device (e.g., mobile device 504, etc.) or may be distributed across multiple systems/devices. All such embodiments are within the scope of the present disclosure.

Still referring to FIG. 11B, BMS-BIM integrator 1104 is shown receiving a BIM and BMS points. In some embodiments, BMS-BIM integrator 1104 receives a BIM from BIM database 1108. In other embodiments, the BIM is uploaded by a user or retrieved from another data source (e.g., remote system 514, etc.). BMS-BIM integrator 1104 may receive BMS points from network 510 (e.g., a BACnet network, a LonWorks network, etc.). The BMS points may be measured data points, calculated data points, setpoints, or other types of data points used by target 502, generated by target 502, or stored within target 502 (e.g., configuration settings, control parameters, equipment information, alarm information, etc.).

BMS-BIM integrator 1104 may be configured to integrate the BMS points with the BIM. In some embodiments, BMS-BIM integrator 1104 integrates the BMS points with the BIM based on a user-defined mapping. For example, BMS-BIM integrator 1104 may be configured to generate a mapping interface within online values interface 1100 that presents the BMS points as a BMS tree and presents the BIM objects as a BIM tree. The BMS tree and the BIM tree may be presented to a user via online values interface 1100. The mapping interface may allow an operator to drag and drop BMS points onto objects of the BIM or otherwise define associations between BMS points and BIM objects. In other embodiments, BMS-BIM integrator 1104 automatically maps the BMS points to BIM objects based on attributes of the BMS points and the BIM objects (e.g., name, attributes, type, etc.).

In some embodiments, BMS-BIM integrator 1104 updates or modifies the BIM to include the BMS points. For example, BMS-BIM integrator 1104 may store the BMS points as properties or attributes of objects within the BIM (e.g., objects representing building equipment or spaces). The modified BIM with integrated BMS points may be provided to integrated BMS-BIM viewer 1106 and/or stored in BIM database 1108. When the BIM is viewed, the BMS points can be viewed along with the other attributes of the BIM objects. In other embodiments, BMS-BIM integrator 1104 generates a mapping between BIM objects and BMS points without modifying the BIM. The mapping may be stored in a separate database or included within the BIM. When the BIM is viewed, integrated BMS-BIM viewer 1106 may use the mapping to identify BMS points associated with BIM objects.

Integrated BMS-BIM viewer 1106 is shown receiving the BIM with integrated BMS points from BMS-BIM integrator 1104. Integrated BMS-BIM viewer 1106 may generate a 3D graphical representation of the building and the components contained therein, according to the attributes of objects defined by the BIM. As previously described, the BIM objects may be modified to include BMS points. For example, some or all of the objects within the BIM may be modified to include an attribute identifying a particular BMS point (e.g., a point name, a point ID, etc.). When integrated BMS-BIM viewer 1106 renders the BIM with integrated BMS points, integrated BMS-BIM viewer 1106 may use the identities of the BMS points provided by the BIM to retrieve corresponding point values from network 510. Integrated BMS-BIM viewer 1106 may incorporate the BMS point values within the BIM to generate a BIM with integrated BMS points and values.

Integrated BMS-BIM viewer 1106 is shown providing the BIM with integrated BMS points and values to online values interface 1100. Online values interface 1100 may present the BIM with integrated BMS points and values to a user. Advantageously, the BIM with integrated BMS points and values may include real-time data from Network 510, as defined by the integrated BMS points. A user can monitor target 502 and view present values of the BMS points from within the BIM, as presented through online values interface 1100. In some embodiments, the BIM with integrated BMS points and values includes trend data for various BMS points. Online values interface 1100 may display the trend data to a user along with the BIM.

In some embodiments, integrated BMS-BIM viewer 1106 receives control actions via online values interface 1100. For example, a user can write new values for any of the BMS points displayed in the BIM (e.g., setpoints), send operating commands or control signals to the building equipment displayed in the BIM, or otherwise interact with target 502 via the BIM. Control actions submitted via online values interface 1100 may be received at integrated BMS-BIM viewer 1106 and provided to network 510. Network 510 may use the control actions to generate control signals for target 502 or otherwise adjust the operation of BMS 400. In this way, the BIM with integrated BMS points and values not only allows a user to monitor target 502, but also provides the control functionality of a graphical management and control interface for target 502.

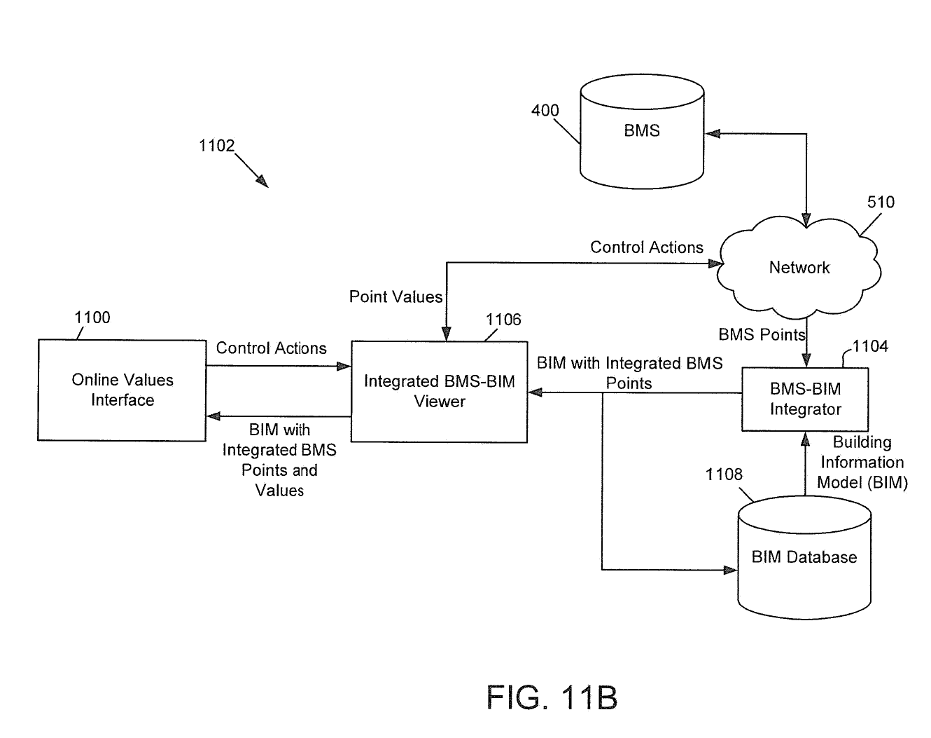

Referring now to FIG. 12, a documentation interface 1200 which can be generated by mobile application 611 is shown, according to an exemplary embodiment. Selection of documentation button 537 within documentation interface 1200 causes a documentation interface 1200 to be displayed on display 522. Documentation interface 100 may present the operator with a document viewer 1202. Document viewer 1202 may perform as the document viewer described above with respect to system 500 and process 550. Document viewer 1202 may, for example, present the operator with various documentation relating to target 502. In one example, documentation interface 1200 provides the documentation to the operator in a list. From the list, the operator may select documentation to view. In various embodiments, documentation interface 1200 is shown on display 522 in full-screen. In other embodiments, documentation interface 1200 is shown on display 522 in less than full-screen.

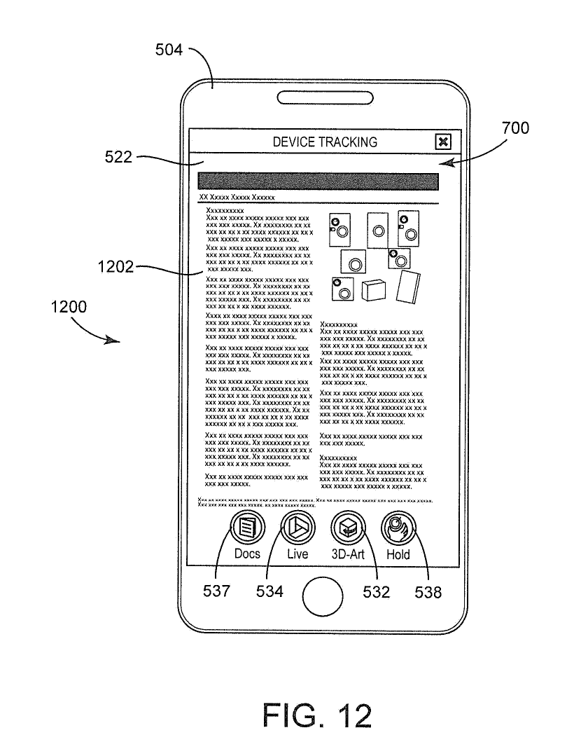

Referring now to FIG. 13, a hold interface 1300 which can be generated by mobile application 611 is shown, according to an exemplary embodiment. Hold interface 1300 may be provided to the operator when the hold button 538 has been selected. Alternatively, movement of mobile device 504 relative to target 502 may cause hold interface 1300 to be provided to the operator. As shown, 3D model 524 remains in the position at which hold button 538 was selected. In this way, the operator can freely move around without having to maintain mobile device 504 at a particular location.

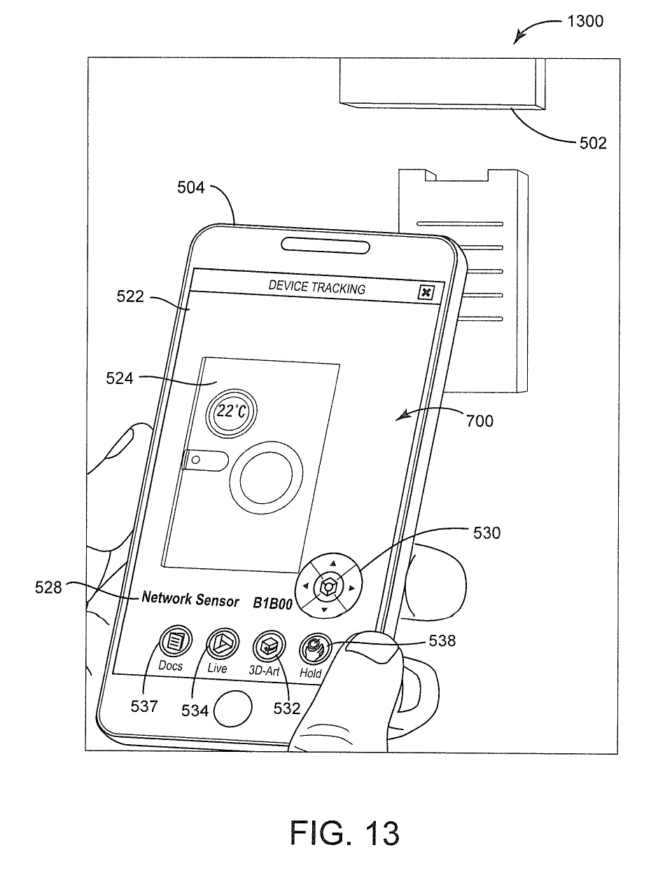

FIGS. 14-18 illustrate a user interface which can be generated by mobile application 611 where target 502 is an image 1400 of a target (e.g., printed on paper, a drawing, a photograph, a 2D image, etc.). Image 1400 may be formed on a piece of paper, a brochure, a catalogue, a posted or other similar physical medium. When using image 1400, system 500 and process 550 may be particularly advantageous because a physical version of target 502 is not required. For example, an operator can easily interact with 3D model 524 without traveling to the location of target 502. These implementations of system 500 and process 550 may be particularly useful when demonstrating or selling target 502 (e.g., to a potential customer, etc.). Alternatively, these implementations of system 500 and process 550 may be particularly useful when an operator does not wish to travel to target 502. For example, simply scanning image 1400 may allow the operator to interact with target 502.

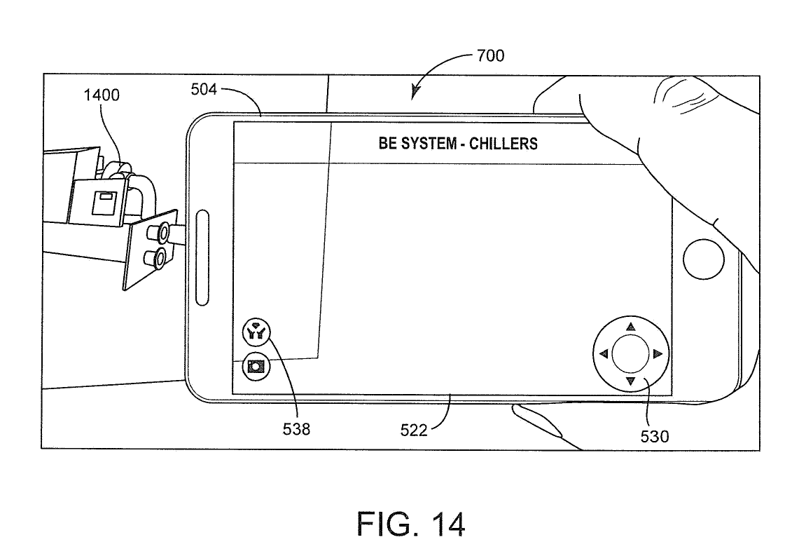

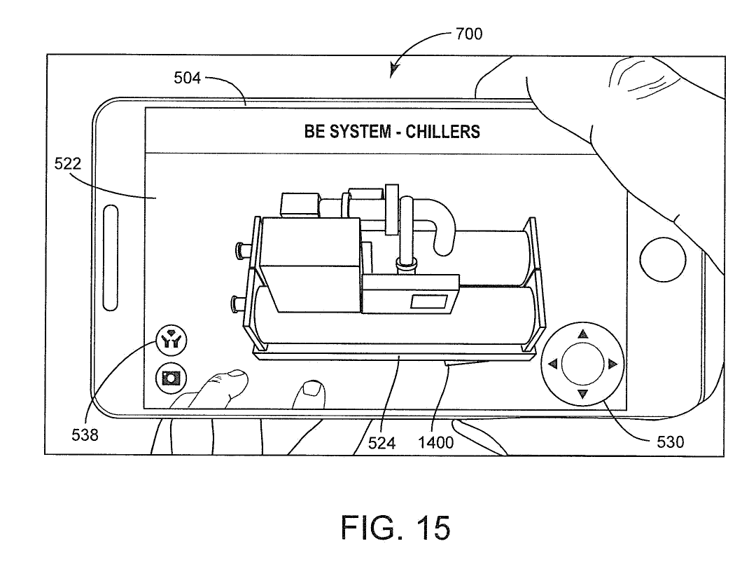

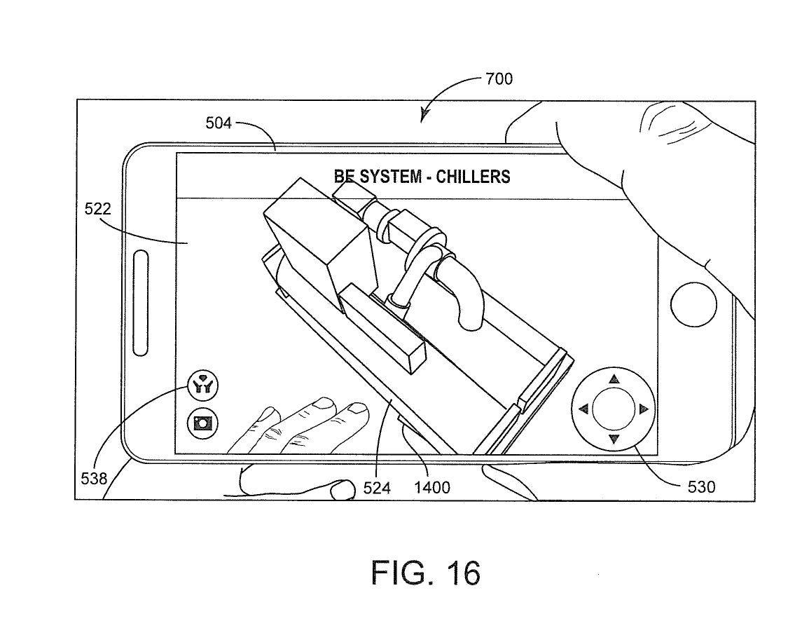

As shown in FIG. 15, 3D model 524 may be shown on top of (e.g., superimposed on, etc.) image 1400 in the same way that 3D model 524 can be shown on top of target 502. Referring to FIG. 16, as image 1400 is rotated, 3D model 524 may be similarly rotated. In this way, the position and orientation of 3D model 524 may be tied to that of image 1400. However, when hold button 538 is selected by the operator, image 1400 may be removed and 3D model 524 will remain shown on display 522. According to various embodiments, while 3D model 524 is shown on display after hold button 538 has been selected, image data from imaging device 600 is still provided to, and shown on, display 522. For example, as shown in FIG. 17, 3D model 524 may remain shown on display 522 as the operator walks around a building. In this way, the operator can visualize how target 502 would appear if installed at any location in the building. After hold button 538 has been selected by the operator, other functions of mobile application 611 remain functional. For example, the operator can utilize input button 530 to rotate 3D model 524 when the operator is at a desired location in the building, eliminating the need for the operator to carry image 1400 when moving through the building.

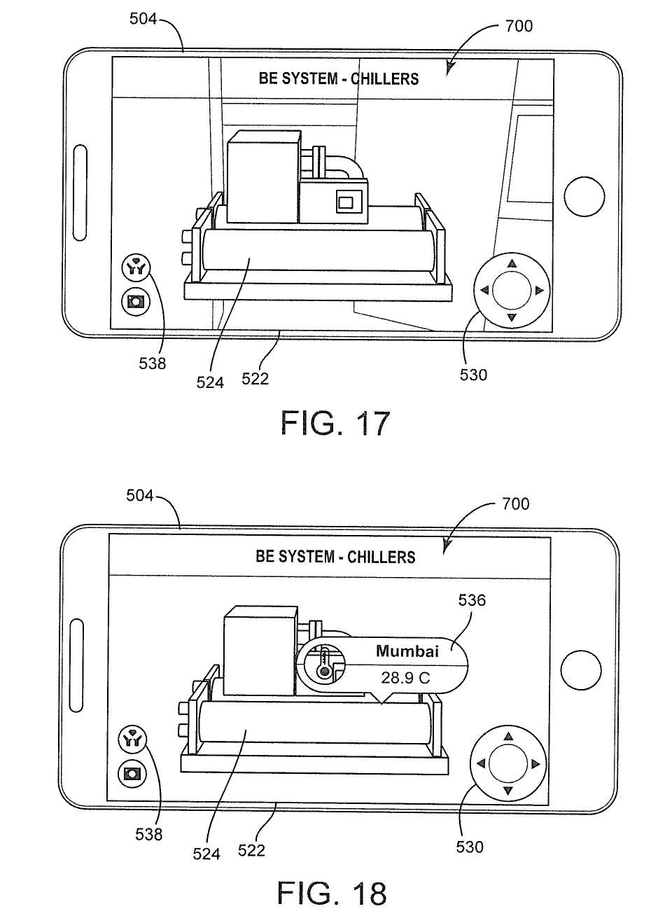

According to an exemplary embodiment, mobile application 611 can link (e.g., associate, etc.) image 1400 with a corresponding target 502. For example, mobile application 611 can link image 1400 of a chiller with target 502 which is the chiller installed on the second floor of the building. In this way, mobile application 611 can associate operating parameters from the corresponding target 502 with image 1400. According to an exemplary embodiment, online values pane 536 can be displayed over image 1400, to display the operating parameters from the corresponding target 502, if the operator selects (e.g., presses on, etc.) 3D model 524. As shown in FIG. 18, online values pane 536 may be displayed partially on top of (e.g., superimposed on, etc.) 3D model 524. Following this example, when 3D model 524 is rotated, online values pane 536 may be correspondingly rotated.

In some embodiments, mobile application 611 may be presented differently depending on credentials (e.g., username and password, personal identification credentials, passcode, security question, device ID, network ID, etc.) associated with the operator. For example, mobile application may require the operator to log in to a user profile. The user profile may have an associated access level, as assigned by, for example, a system administrator. The access level may determine which capabilities of mobile application 611 are available to the operator. In other examples, the access level may be determined based on biometric inputs (e.g., face recognition, fingerprint recognition, iris recognition, etc.). For example, an operator with a relatively low access level may not be able to access online values pane 536 or may be restricted from changing operating characteristics of target 502.

System 500 and process 550 may improve operator interaction with the building. For example, if a fault is reported in the building (e.g., by a customer, by a tenant, etc.), the operator can go to the room where target 502 having the fault is located. The operator may be provided with 3D model 524 of target 502 showing failure points (e.g., fault locations, disconnections, error readings, etc.) in the operation of target 502. The operator may also be provided through mobile application 611 with various service actions (e.g., work order details, contact service representative, order parts, emergency shutdown, manual override, etc.) corresponding to the failure points in target 502. System 500 and process 550 may allow the operator to visualize augmented information about target 502 thereby increasing the efficiency of the operator leading to potential cost savings in operation of the building.

System 500 and process 550 may facilitate operational assistance for target 502 while the operator is remote compared to target 502. For example, if target 502 requires maintenance or inspection, system 500 and process 550 may be implemented by an operator that is not in the same building as target 502. In this way, system 500 and process 550 facilitate remote interaction with target 502.

In another example, system 500 and process 550 may facilitate quick access by the operator of checklists and work manuals pertaining to target 502. The operator may observe, through mobile application 611, the exact design or working conditions of target 502 and follow step-by-step visual and/or audio instructions for how to service, repair, or maintain target 502. For example, mobile application 611 may provide the operator with a tutorial, shown on 3D model 524 of target 502, of how to change an air filter of target 502.

System 500 and process 550 can be implemented by a salesman to facilitate the sale of target 502. For example, system 500 and process 550 may allow the salesman to demonstrate target 502 to a customer without the need for carrying numerous brochures, catalogues, and other documents. Instead, system 500 and process 550 can be utilized by the customer to visualize target 502 operating in a target building (e.g., the customer's building, etc.). In some applications, system 500 and process 550 may be implemented to compare target 502 with other similar products (e.g., competitor products, etc.). In these ways, system 500 and process 550 may decrease an amount of space needed in a sales showroom and increase the efficiency and effectiveness of the salesman.

According to various embodiments, the operator may utilize mobile device 504 to share content with other operators (e.g., via Bluetooth, via Wi-Fi, via NFC, etc.). For example, the operator may utilize mobile device 504 to selectively transmit content to another operator's mobile device or visualization device. Depending on the access level of the other operator, the other operator may or may not have the ability to access certain content (e.g., controls, etc.).

Mobile application 611 may be implemented with, for example, any of a headset (e.g., ODG R-7 Glasses, ATHEER AiR, Samsung Gear VR®, Oculus Rift®, Google Cardboard®, Microsoft HoloLens®, HTC Vive®, Razer OSVR®, PlayStation VR®, Carl Zeiss Cinemizer®, Starbreeze StarVR®, etc.), an input device (e.g., Samsung Galaxy S6®, Samsung Galaxy Note 4®, iPhone 6®, iPad Air®, iPad Pro®, Nokia OZO Camera®, Leap Motion®, Intugine Nimble VR®, Sixense®, Virtuix Omni®, ZSpace®, etc.), software (e.g., Unity®, Oculus® Unity Package, Sixense® Unity plug-in, MiddleVR®, Virtual Human Toolkit, Impulsonic®, VREAM®, vorpX®, Vizard®, etc.), and content. Mobile device 504 may include, for example, batteries (e.g., dual 650 mAh lithium-ion, etc.), a touchscreen, control buttons (i.e., for interacting with content, etc.), sensors (e.g., accelerometer, gyroscope, altitude sensor, etc.), charging ports (e.g., magnetic USB, etc.), audio ports (e.g., magnetic stereo audio ports with ear buds, etc.), and other similar components.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements; values of parameters; mounting arrangements; use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, by a special purpose computer processor for an appropriate system incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

The background section is intended to provide a background or context to the invention recited in the claims. The description in the background section may include concepts that could be pursued but are not necessarily ones that have been previously conceived or pursued. Therefore, unless otherwise indicated herein, what is described in the background section is not prior art to the present invention and is not admitted to be prior art by inclusion in the background section.

What is claimed is:

1. A system for locating a target in a building, the system comprising:
a mobile application for implementation on a mobile device comprising a camera configured to be utilized by the mobile application to selectively obtain a first image data of a first environment; and
a remote system configured to:
selectively receive the first image data from the mobile application;
compare, in response to receiving the first image data from the mobile application, the first image data to a database of targets;
determine if a portion of the first image data is indicative of a target in the database of targets; and
transmit, in response to determining that a portion of the first image data is indicative of a determined target, a target indication to the mobile application, the target indication comprising a 3D model associated with the determined target;
wherein the mobile application is further configured to selectively provide, in response to receiving the target indication from the remote system, the 3D model on a display of a mobile device.

2. The system of claim 1, further comprising a building management system (BMS) communicable with a network and configured to:
receive the target indication from the network;
determine, in response to receiving the target indication, an operating parameter associated with the determined target; and
provide the operating parameter to the mobile application;
wherein the mobile application is further configured to selectively provide, in response to receiving the operating parameter from the BMS, the operating parameter on a display of a mobile device.

3. The system of claim 2, wherein the mobile application is further configured to provide the operating parameter on a display of a mobile device in response to receiving a selection made by a user in the mobile application.

4. The system of claim 2, wherein the mobile application is further configured to:
facilitate interaction with the determined target by a user, the interaction causing a change in the operating parameter; and
display the change in the operating parameter on the 3D model on a display of a mobile device.

5. The system of claim 1, wherein the mobile application is further configured to:
provide, in response to obtaining the first image data from the camera, the first image data on a display of a mobile device; and
overlay, in response to receiving the target indication from the remote system, the 3D model on the first image data on a display of a mobile device.

6. The system of claim 5, wherein:
the camera is further configured to be utilized by the mobile application to selectively obtain a second image data of a second environment; and
the mobile application is further configured to:
obtain the second image data from the camera;
provide, in response to obtaining the second image data from the camera, the second image data on a display of a mobile device; and
overlay the 3D model on the second image data on a display of a mobile device.

7. The system of claim 5, wherein the mobile application is further configured to:
receive a selection made by a user in the mobile application; and
at least one of:
rotate, in response to receiving the selection, the 3D model relative to the first image data; and
explode, in response to receiving the selection, the 3D model.

8. A system for locating a target in a building, the system comprising:
a mobile application for implementation on a mobile device and configured to communicate via a network, the mobile device comprising:
an imaging device configured to be utilized by the mobile application to selectively obtain image data of an environment;
a display configured to:
selectively provide the image data to a user; and
receive a first command from the user; and
a communications device configured to transmit, in response to receiving the first command from the user, the image data via the network; and
a remote system configured to communicate via the network and configured to:
selectively receive the image data from the mobile device via the network;
compare, in response to receiving the image data from the mobile device, the image data to a database of targets;
determine if a portion of the image data is indicative of a target in the database of targets; and
transmit, in response to determining that a portion of the image data is indicative of a determined target in the database of targets, a target indication to at least one of the mobile device or a building management system (BMS) via the network, the target indication comprising a 3D model associated with the target.

9. The system of claim 8, wherein the mobile application is configured to display, in response to receiving the target indication via the network, the 3D model on the display of the mobile device.

10. The system of claim 9, wherein the BMS is configured to:
determine, in response to receiving the target indication, an operating parameter associated with the determined target; and
provide the operating parameter to the mobile application via the network.

11. The system of claim 10, wherein the mobile application is configured to display, in response to receiving the operating parameter via the network, the operating parameter on the display of the mobile device while the 3D model is displayed on the display of the mobile device.

12. The system of claim 11, wherein:
the mobile application is further configured to provide a selectable button on the display, the selectable button corresponding with the operating parameter;
the display is configured to receive a second command from the user in response to a selection of the selectable button by the user, the second command different from the first command;
the communications device is further configured to transmit, in response to receiving the second command from the user, the second command to the BMS via the network; and
the BMS is configured to interact, in response to receiving the second command via the network, with the determined target to change the operating parameter according to the second command.

13. The system of claim 8, wherein:
the database of targets comprises at least one of edge detection data, shape recognition data, color detection data, and object recognition data for each target in the database of targets;
the remote system is further configured to obtain, in response to receiving the image data from the network, at least one of edge detection data, shape recognition data, color detection data, and object recognition data for the image data; and
the comparison performed by the remote system is a comparison of the at least one of edge detection data, shape recognition data, color detection data, and object recognition data for the image data with the at least one of edge detection data, shape recognition data, color detection data, and object recognition data for each target in the database of targets.

14. The system of claim 8, wherein the remote system is configured to determine if a portion of the image data is indicative of a target in the database of targets independent of any data provided by a marker present in the image data.

15. A system for locating a target in a building, the system comprising:
a mobile application for implementation on a mobile device and configured to:
obtain a first image data of a first environment;
provide the first image data to a display of the mobile device; and
transmit the first image data; and
a remote system communicable with the mobile application and configured to:
receive the first image data from the mobile application
compare the first image data to a database of targets;
determine if a portion of the first image data is indicative of a target in the database of targets; and
transmit, in response to determining that a portion of the first image data is indicative of a determined target in the database of targets, a target indication to the mobile application;
wherein the mobile application is configured to provide the target indication on the display of the mobile device.

16. The system of claim 15, wherein the remote system is configured to determine that a portion of the first image data is indicative of the determined target in the database of targets independent of any data provided by a marker present in the first image data.

17. The system of claim 15, wherein the mobile application is further configured to:
provide the first image data on the display of the mobile device; and
overlay the target indication on the first image data on the display of the mobile device.

18. The system of claim 17, wherein the mobile application is further configured to:
obtain a second image data of a second environment;
provide the second image data on the display of the mobile device in place of the first image data; and
overlay the target indication on the second image data on the display of the mobile device.

19. The system of claim 15, further comprising a building management system (BMS) communicable with the mobile application and configured to:
receive the target indication from the mobile application;
determine an operating parameter associated with the determined target; and
provide the operating parameter to the mobile application;
wherein the mobile application is further configured to selectively provide, in response to receiving the operating parameter from the BMS, the operating parameter on the display of the mobile device.

20. The system of claim 19, wherein the mobile application is further configured to:
facilitate interaction with the determined target by a user, the interaction causing a change in the operating parameter; and
display the change in the operating parameter on the 3D model on the display of the mobile device.
